(19) United States
(12) Patent Application Publication
(10) Pub. No.: US 2015/0168806 A1
(43) Pub. Date: Jun. 18, 2015

(54) LENS BARRIER, BARREL ASSEMBLY INCLUDING THE LENS BARRIER, AND ELECTRONIC APPARATUS INCLUDING THE BARREL ASSEMBLY

(71) Applicant: SAMSUNG ELECTRONICS CO., LTD., Suwon-si (KR)

(72) Inventor: Jong-jun Kim, Suwon-si (KR)

(73) Assignee: SAMSUNG ELECTRONICS CO., LTD., Suwon-si (KR)

(21) Appl. No.: 14/282,334

(22) Filed: May 20, 2014

(30) Foreign Application Priority Data
Dec. 13, 2013 (KR) 10-2013-0155642

(51) Int. Cl. G03B 11/04; G02B 27/00

(52) U.S. Cl. CPC G03B 11/043; G02B 27/0006

(57) ABSTRACT

A lens barrier is described. The lens barrier includes: a base having an open portion that provides an optical path; a plurality of blades that are rotatably mounted to the base so as to move between an opening position where the open portion is opened and a closing position where the open portion is closed; and a driving member that provides a driving force to the plurality of blades to rotate the plurality of blades. A forward guide, for moving the driving member forward along an optical axis such that the driving member approaches the plurality of blades, and a backward guide, for moving the driving member away from the plurality of blades when the plurality of blades is at the closing position, are formed at at least one of the driving member or the base.

### CROSS REFERENCE TO RELATED PATENT APPLICATIONS

This application claims the priority benefit of Korean Patent Application No. 10-2013-0155642, filed on Dec. 13, 2013, in the Korean Intellectual Property Office, the disclosure of which is incorporated by reference herein in its entirety.

### BACKGROUND

1. Field

Various embodiments described herein relate to a lens barrier, a barrel assembly including the lens barrier, and an electronic apparatus including the barrel assembly, and more particularly, to a lens barrier capable of preventing vibration noise, a barrel assembly including the lens barrier, and an electronic apparatus including the barrel assembly.

2. Related Art

In general, an electronic apparatus or photographing apparatus such as a digital still camera or a digital video camera includes a barrel assembly. Depending on a structure of the digital still camera, the barrel assembly may be of an exchangeable lens type, in which a camera body and an exchangeable lens are separable, or a fixed type, in which a lens is fixed to a camera body.

The barrel assembly may protrude from a body to perform a photographing operation and may be received in the body after the photographing operation is completed. While the photographing operation is performed, an end portion of the barrel assembly is closed to protect internal components such as a lens. To this end, a lens barrier to determine whether to expose the lens may be installed in front of a barrel of the barrel assembly.

The lens barrier may include a blade that opens or closes an open portion that provides an optical path. The blade may rotate in a direction to cross an optical axis, thereby opening or closing the open portion. In order for the blade to rotate in a direction to cross the optical axis, a predetermined clearance is necessary in an optical axis direction.

However, the predetermined clearance may make the blade vibrate, which causes noise. In particular, if a vibration module is included in the electronic apparatus, noise is caused every time when the blade vibrates, which may inconvenience a user.

### SUMMARY

Various embodiments include a lens barrier capable of reducing noise by vibration, a barrel assembly including the lens barrier, and an electronic apparatus including the barrel assembly.

One or more embodiments include a lens barrier that provides a sufficient clearance for rotation of a blade of the lens barrier while the blade is being rotated, the clearance having a minimum value when the blade is in a fixed state, a barrel assembly including the lens barrier, and an electronic apparatus including the barrel assembly.

One or more embodiments include a lens barrier that stably presses a driving member with respect to a blade of the lens barrier or stops pressing the driving member when the blade of the lens barrier is in a fixed state so that the blade is stably rotated and noise is minimized at the same time, a barrel assembly including the lens barrier, and an electronic apparatus including the barrel assembly.

Additional embodiments will be set forth in part in the description which follows and, in part, will be apparent from the description, or may be learned by practice of the presented embodiments.

According to one or more embodiments, a lens barrier includes: a base having an open portion that provides an optical path; a plurality of blades that are rotatably mounted to the base and movable between an opening position where the open portion is opened and a closing position where the open portion is closed; and a driving member that provides a driving force to the plurality of blades to rotate the plurality of blades. A forward guide, for moving the driving member forward along an optical axis such that the driving member approaches the plurality of blades, and a backward guide, for moving the driving member away from the plurality of blades when the plurality of blades is at the closing position, are formed at at least one of the driving member or the base.

The driving member may be rotatable in a first direction and a second direction opposite the first direction, and wherein, when the plurality of blades is at the closing position, a clearance between the driving member and the plurality of blades is reduced as the driving member rotates in the first direction, and wherein, when the plurality of blades is at the closing position, the clearance between the driving member and the plurality of blades increases as the driving member rotates in the second direction.

The forward guide may be formed on a rear surface of the driving member, and the backward guide may be formed on a front surface of the driving member.

The forward guide may be downwardly inclined in the first direction.

The backward guide may be downwardly inclined in the first direction.

The base may include a forward supporting portion that contacts the forward guide and a rear supporting portion that contacts the backward guide.

The plurality of blades may be disposed between the base and the driving member.

When the plurality of blades is at the closing position, a clearance between the driving member and the base may vary as the driving member rotates.

When the plurality of blades move from the opening position to the closing position, a clearance between the driving member and the base may be constant.

According to one or more embodiments, a barrel assembly includes a barrel that supports at least one lens and a lens barrier that is disposed in front of the barrel and that is moved in a direction to cross an optical axis of the lens to open or close the lens. The lens barrier includes: a base having an open portion that provides an optical path; a plurality of blades that are rotatably mounted to the base and movable between an opening position where the open portion is opened and a closing position where the open portion is closed; and a driving member that provides a driving force to the plurality of blades to rotate the blades. A forward guide, for moving the driving member forward along an optical axis such that the driving member approaches the plurality of blades, and a backward guide, for moving the driving member away from the plurality of blades when the plurality of blades is at the closing position, are formed at at least one of the driving member or the base.

The driving member may be rotatable in a first direction and a second direction opposite to the first direction, and wherein, when the plurality of blades is at the closing position, a clearance between the driving member and the plurality of blades is reduced as the driving member rotates in the first direction, and wherein, when the plurality of blades is at the closing position, the clearance between the driving member and the plurality of blades increases as the driving member rotates in the second direction.

The forward guide may be formed on a rear surface of the driving member, and the backward guide is formed on a front surface of the driving member.

The forward guide may be downwardly inclined in the first direction.

The backward guide may be downwardly inclined in the first direction.

The base may include a forward supporting portion that contacts the forward guide and a rear supporting portion that contacts the backward guide.

The plurality of blades may be disposed between the base and the driving member.

When the plurality of blades is at the closing position, a clearance between the driving member and the base may vary as the driving member rotates.

When the plurality of blades move from the opening position to the closing position, the clearance between the driving member and the base may be constant.

According to one or more embodiments, an electronic apparatus includes: a main body including a vibration module; a barrel that supports at least one lens and is movably disposed in the main body to be protrudable from a front part of the main body; and a lens barrier that is disposed in front of the barrel and that is moved in a direction to cross an optical axis of the lens to open or close the lens. The lens barrier includes: a base having an open portion that provides an optical path; a plurality of blades that are rotatably mounted to the base and movable between an opening position where the open portion is opened and a closing position where the open portion is closed; and a driving member that provides a driving force to the plurality of blades to rotate the blades. A forward guide, for moving the driving member forward along an optical axis such that the driving member approaches the plurality of blades, and a backward guide, for moving the driving member away from the plurality of blades when the plurality of blades is at the closing position, are formed at at least one of the driving member or the base.

### BRIEF DESCRIPTION OF THE DRAWINGS

These and/or other embodiments will become apparent and more readily appreciated from the following description of various embodiments, taken in conjunction with the accompanying drawings in which:

FIG. 1 is a perspective view illustrating an electronic apparatus according to an embodiment;

FIGS. 2A and 2B are perspective views illustrating the electronic apparatus of FIG. 1 viewed from a different angle, respectively showing a barrel assembly in a protruding state and in a received state;

FIG. 3 is a schematic exploded perspective view illustrating a portion of the barrel assembly illustrated in FIG. 2 according to an embodiment;

FIGS. 4A and 4B are exploded perspective views illustrating a lens barrier of FIG. 3 from different angles;

FIG. 5 is a rear perspective view of the lens barrier of FIG. 3;

FIG. 6 is a partial cross-sectional view of the lens barrier of FIG. 5;

FIGS. 7A through 7C are partial expanded views of portions of the lens barrier of FIG. 5, sequentially illustrating operating states of a base, a blade, and a driving member as the driving member rotates in a first direction R1;

FIGS. 8A through 8C are cross-sectional diagrams illustrating a forward guide of the driving member and a forward movement supporting unit of a base of FIGS. 7A through 7C;

FIGS. 9A through 9C are cross-sectional diagrams illustrating a backward guide of the driving member and a rear movement supporting unit of the base of FIGS. 7A through 7C; and

FIGS. 10A through 10C are partial cross-sectional views of a lens barrier of FIGS. 7A through 7C.

### DETAILED DESCRIPTION

Reference will now be made in detail to various embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain features of the present description. Expressions such as “at least one of,” when preceding a list of elements, modify the entire list of elements and do not modify the individual elements of the list.

Hereinafter, various examples of structures and functions of a lens barrier 100, a barrel assembly 10, and an electronic apparatus 1 including the barrel assembly 10 will be described in detail with reference to the attached drawings.

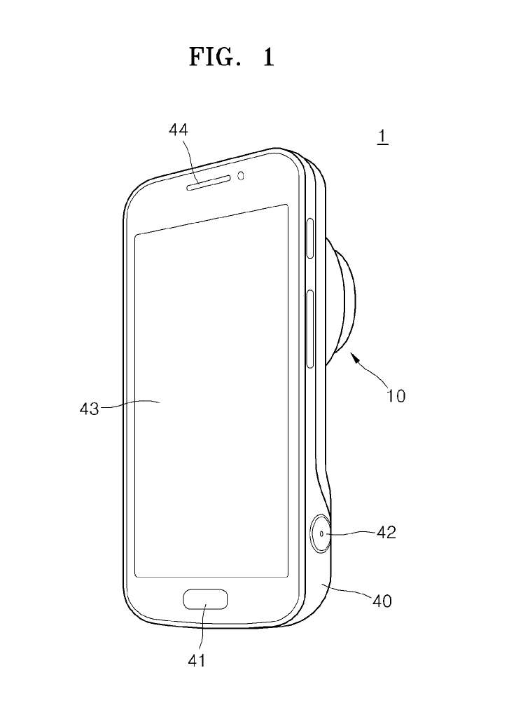

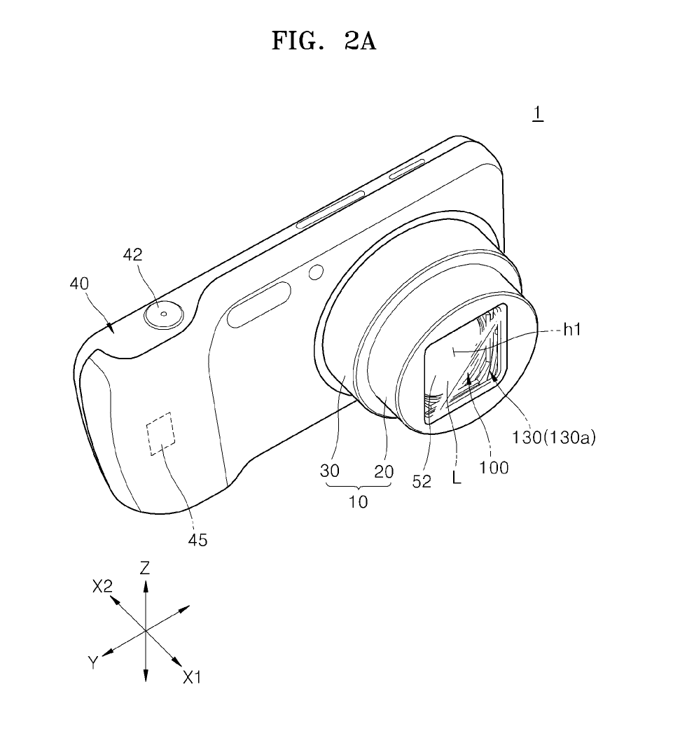

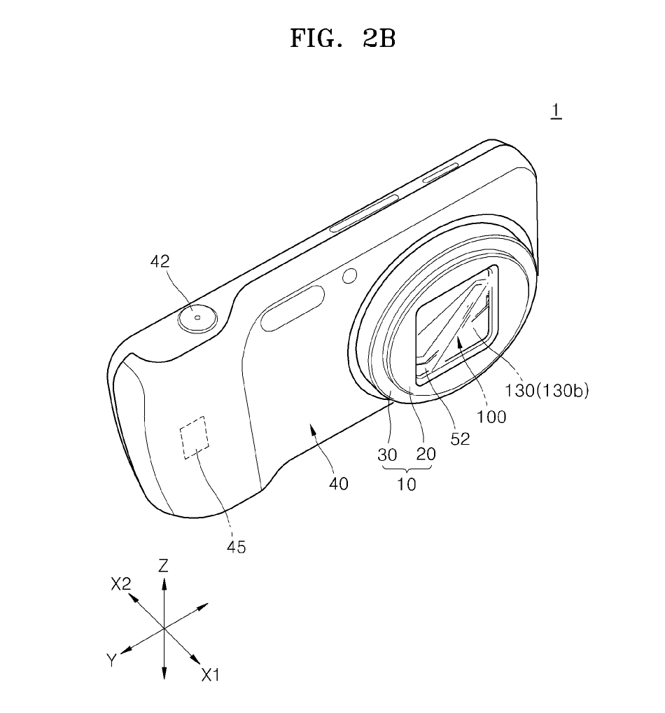

FIG. 1 is a perspective view illustrating the electronic apparatus 1 according to an embodiment. FIGS. 2A and 2B are perspective views illustrating the electronic apparatus 1 of FIG. 1 viewed from a different angle and respectively showing the barrel assembly 10 in a protruding state and in a received state.

Referring to FIGS. 1, 2A, and 2B, the barrel assembly 10 includes a first barrel 20 and a second barrel 30 that movably supports the first barrel 20. The barrel assembly 10 is coupled to a main body 40 of the electronic apparatus 1, and may move between a location where the barrel assembly 10 is protruded from a front part of the main body 40 toward a front direction X1 as illustrated in FIG. 2A and a location where the barrel assembly 10 is received in the main body 40 as illustrated in FIG. 2B. The front direction X1 is defined as a direction towards an object (not shown), and a rear direction X2 is defined as a direction opposite the object, that is, a direction towards the main body 40.

The electronic apparatus 1 including the barrel assembly 10 having the above-described structure may be, for example, a mobile device. Input units 41 and 42 via which an input signal is input, a display unit 43 that displays an image, and a speaker 44 that outputs sound may be formed in the main body 40 of the electronic apparatus 1. The display unit 43 may be, for example, a liquid crystal display (LCD) or a flat panel display device using an organic light emitting device (OLED). The display unit 43 may include a touch panel. Also, the main body 40 may include a vibration module 45 that generates one or more predetermined signals to notify a user. The vibration module 45 may be, for example, a vibration motor, but the present embodiment is not limited thereto. The vibration module 45 may vibrate in various ways. The electronic apparatus 1 is not limited to a mobile device, and may also be a digital still camera that captures still images or a digital camcorder that captures a video or a plurality of images.

Although not illustrated in the drawings, the electronic apparatus 1 may include an image capture device (not shown) that converts light that is incident through the barrel assembly 10 into an electrical signal. The image capture device may be a photoelectric conversion device such as a charge coupled device (CCD) or a complementary metal oxide semiconductor (CMOS) device.

The barrel assembly 10 directs light reflecting off an object to the image capture device, and forms an image of the object on a surface of the image capture device. The first barrel 20 and the second barrel 30 of the barrel assembly 10 may each include one or more lenses (not shown).

The first and second barrels 20 and 30 are included in the barrel assembly 10. However, three or more barrels may be included in the barrel assembly 10 in other embodiments, according to optical design requirements.

As the barrel assembly 10 protrudes from or is received in the main body 40 of the electronic apparatus 1 as illustrated in FIG. 2A and FIG. 2B, the lens moves in the front direction X1 (e.g., when protruding from the main body 40) or the rear direction X2 (e.g., when received in the main body 40) along an optical axis. The barrel assembly 10 performs a zooming operation to adjust a magnification of the image with respect to an object of the image and a focusing operation to adjust a focus of the image with respect to the object.

The electronic apparatus 1 illustrated in FIGS. 1, 2A, and 2B is of a fixed barrel type in which the barrel assembly 10 is fixedly mounted to the main body 40 of the electronic apparatus 1, but the various embodiments are not limited to this type. Accordingly, the electronic apparatus 1 may also be of an exchangeable barrel type in which the barrel assembly 10 may be separated from or mounted to the main body 40 of the electronic apparatus 1.

When the electronic apparatus 1 is not performing a photographing operation, the barrel assembly 10 may be received in the main body 40 of the electronic apparatus 1 as illustrated in FIG. 2B. The lens barrier 100 is installed at a front part of the first barrel 20. While the barrel assembly 10 is received in the main body 40, the lens barrier 100 blocks a first open portion h1 through which light is incident, to thereby protect a lens L of the barrel assembly 10. A blade 130 is located at a closing position 130b.

When the electronic apparatus 1 is performing a photographing operation, the barrel assembly 10 protrudes from the main body 40 of the electronic apparatus 1 toward the front direction X1 along an optical axis as illustrated in FIG. 2A. When the barrel assembly 10 protrudes, the blade 130 of the lens barrier 100 moves to the outside of the first open portion h1 so that light passes through the first open portion h1. At this point, the blade 130 is located at an opening position 130a.

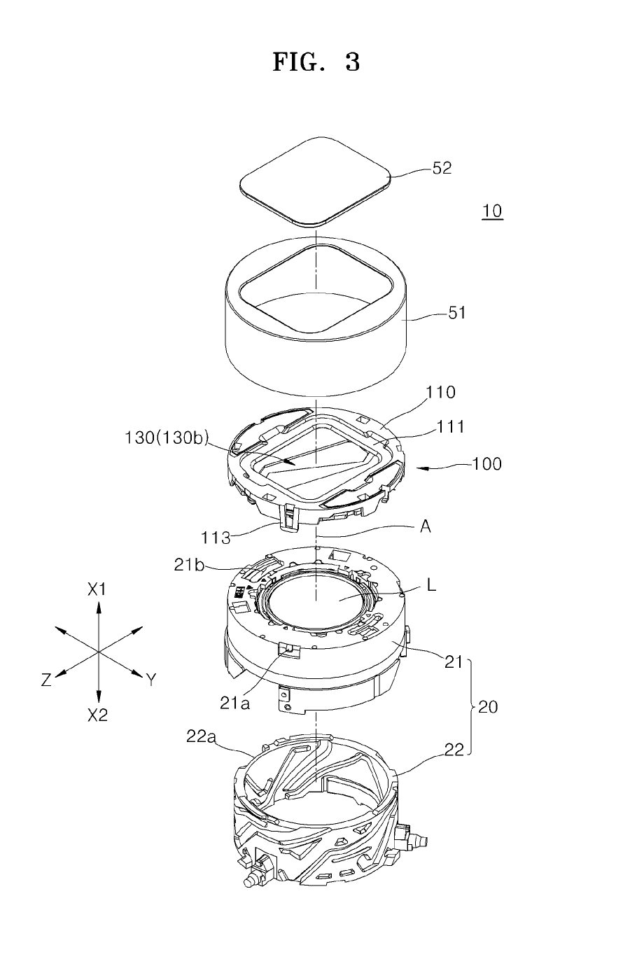

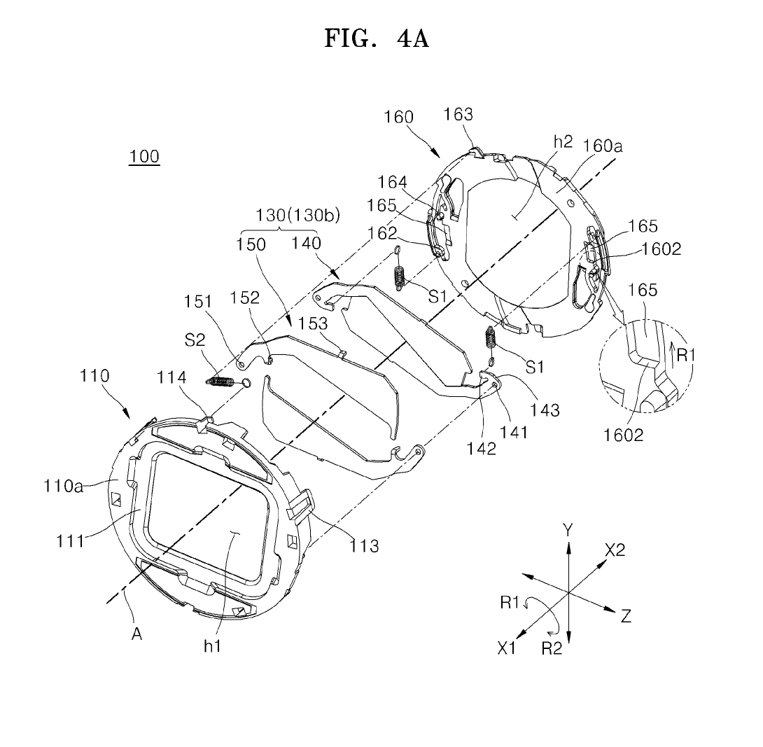

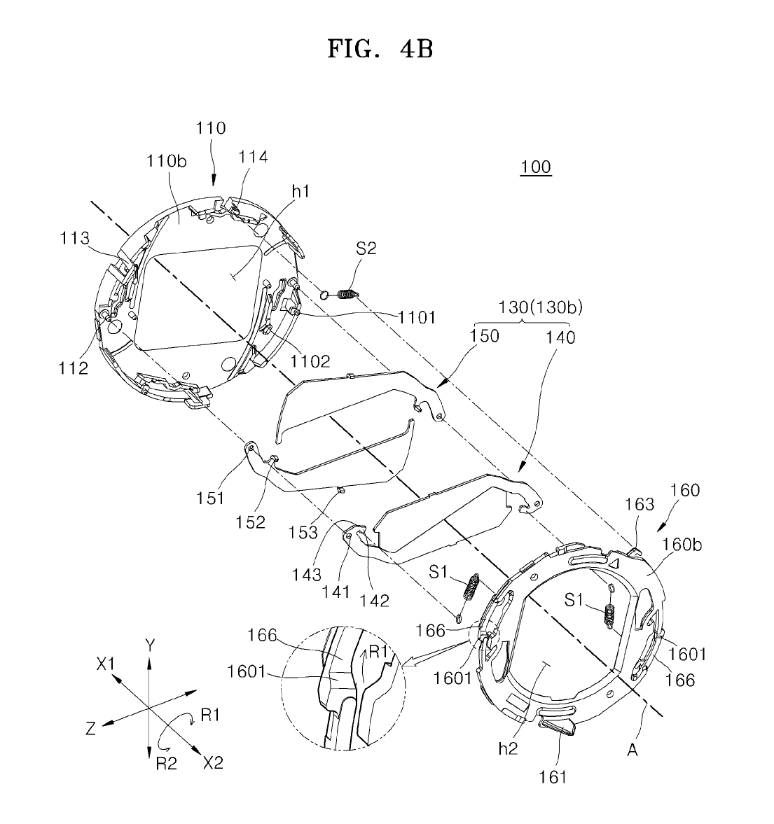

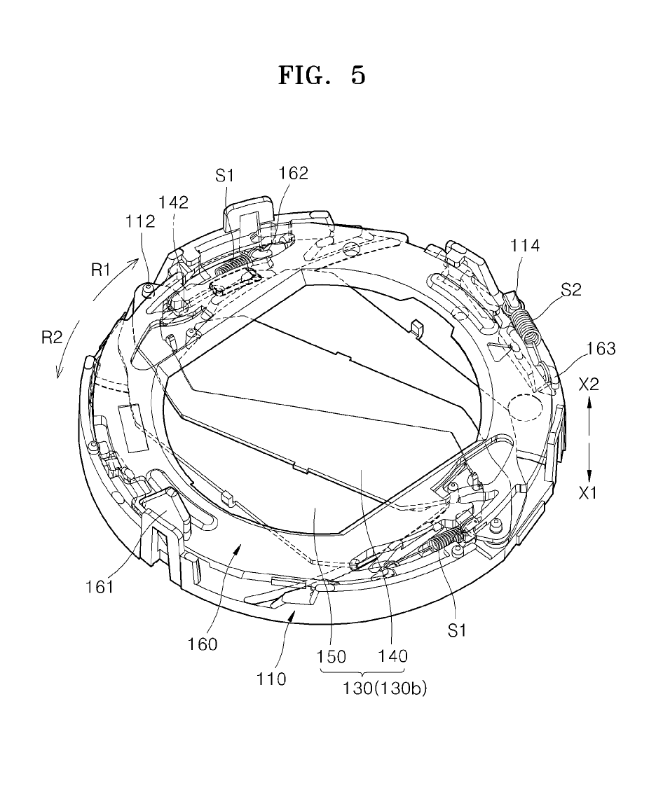

FIG. 3 is a schematic exploded perspective view illustrating a portion of the barrel assembly 10 illustrated in FIG. 2 according to an embodiment. FIGS. 4A and 4B are exploded perspective views illustrating the lens barrier 100 of FIG. 3 from different angles. FIG. 5 is a rear perspective view of the lens barrier 100 of FIG. 3.

Referring to FIG. 3, the barrel assembly 10 includes the first barrel 20 that supports the lens L, the lens barrier 100 that is disposed at the front part of the first barrel 20 and is moved in a direction to cross an optical axis A to expose the lens L, and a decoration ring 51 and a transparent member 52 that are disposed at a front part of the lens barrier 100.

The first barrel 20 has a hollow cylindrical shape, and includes the lens L in a center thereof. The first barrel 20 is inserted into the second barrel 30 (see FIG. 2A), and may be protruded from the second barrel 30 in the front direction X1 or may be inserted into the second barrel 30. The first barrel 20 may include a first cylinder 21 that supports the lens L and a second cylinder 22 that is disposed inside the first cylinder 21. The second cylinder 22 may rotate relative to the first cylinder 21. A plurality of first protrusion portions 21a onto which a base 110 may be inserted to be coupled may be formed on a lateral surface of the first cylinder 21. Also, a first guide hole 21b through which a protrusion 161 of a driving member 160 may pass is formed in the first cylinder 21, and an insertion portion 22a into which the protrusion 161 of the driving member 160 may be inserted may be formed in the second cylinder 22.

The lens barrier 100 is disposed at the front part of the first barrel 20. The lens barrier 100 opens the lens L installed in the first barrel 20 to the outside (e.g., to receive light) or closes the lens L from the outside. The lens barrier 100 blocks light from reaching the lens L when the electronic apparatus 1 does not perform a photographing operation as illustrated in FIG. 2B, thereby protecting the image capture device in the main body 40.

Referring to FIGS. 4A, 4B, and 5, the lens barrier 100 may include the base 110, a plurality of blades 130, and the driving member 160.

The first open portion h1 that provides an optical path is formed in the base 110, and a space for accommodating the plurality of blades 130 is formed in the base 110 for when the plurality of blades 130 move in a direction to cross the optical axis A, around the first open portion h1. A mounting groove 111 into which the transparent member 52 may be mounted is formed in a front surface 110a of the base 110, and a plurality of rotation axes 112 that rotatably support the blades 130 are formed on a rear surface 110b. A plurality of first groove portions 113, into which the first protrusion portions 21a of the first cylinder 21 are inserted, are formed in a lateral surface of the base 110.

The plurality of blades 130 rotate in a direction to cross the optical axis A to thereby open or close the first open portion h1. The plurality of blades 130 are rotatably supported via the rotation axes 112 of the base 110, and may recede to the outside of the first open portion h1 so as to move between the opening position 130a (see FIG. 2A) where the first open portion h1 is opened and the closing position 130b (see FIG. 2B) where the first open portion h1 is closed. The plurality of blades 130 may be disposed between the base 110 and the driving member 160.

The plurality of blades 130 may include a pair of driving blades 140 and a pair of driven blades 150. The pair of driving blades 140 may each have a same shape. A hole 141 is formed in the driving blades 140 to rotatably couple the driving blades 140 to the rotation axes 112 formed on the base 110. A coupling portion 142 through which an end of an elastic member S1 (e.g., a spring) is coupled to the driving blades 140 may be formed at the driving blades 140.

The pair of driven blades 150 may each have a same shape. A hole 151 through which the driven blades 150 are rotatably coupled to the rotation axes 112 is formed in the driven blades 150. The driven blades 150 include a first protrusion 152 and a second protrusion 153 that protrude toward the driving blades 140. When the driving blades 140 rotate to block the first open portion h1 of the base 110, the first protrusion 152 allows the driven blades 150 to move in connection with the driving blades 140. When the driving blades 140 rotate to open the first open portion h1 of the base 110, the second protrusion 153 allows the driven blades 150 to move in connection with the driving blades 140.

The driving member 160 provides a driving force to the driving blades 140. A second open portion h2 may be formed at a position corresponding to the first open portion h1. The driving member 160 is disposed between the first barrel 20 (see FIG. 3) and the blades 130, and transfers a driving force received from the first barrel 20 to the blades 130. In order for the driving member 160 to receive a driving force from the first barrel 20, the driving member 160 includes the protrusion 161 that is inserted into the insertion portion 22a of the second cylinder 22 (see FIG. 3). A plurality of first coupling portions 162, one or more second coupling portions 163, and a plurality of pressing pins 164 are formed in the driving member 160. The first coupling portions 162 are connected to the coupling portion 142 of the driving blades 140 via the first elastic member S1. The pressing pins 164 may press a predetermined area 143 or interrupt a pressed state, according to a first or second rotational direction R1 or R2 of the driving member 160. The second coupling portions 163 are connected to a coupling portion 114 of the base 110 via a second elastic member S2.

Hereinafter, an opening and closing operation of the lens barrier 100 including the base 110, the blades 130, and the driving member 160 will be described.

Referring to FIGS. 4A, 4B, and 5, the driving member 160 which rotates in the first rotational direction R1 or in the second rotational direction R2 transfers a driving force to the driving blades 140 via the first coupling portions 162, the second coupling portions 163, and the pressing pins 164 so as to rotate the blades 130 to the opening portion 130a or the closing position 130b.

When the driving member 160 rotates in the first rotational direction R1, for example, clockwise, an external force is applied to the coupling portion 142 of the driving blades 140 via the first elastic member 51. Accordingly, the blades 130 rotate in a counter-clockwise direction with respect to the rotation axes 112 to be moved from the opening position 130a to the closing position 130b.

When application of an external force with respect to the driving member 160 is stopped, the driving member 160 rotates in the second direction R2, which is opposite the first direction R1, for example, in a counterclockwise direction, via the second elastic member S2. When the driving member 160 rotates in the second direction R2, the pressing pins 164 of the driving member 160 press the predetermined areas 143 of the driving blades 140. Accordingly, the blades 130 rotate clockwise with respect to the rotation axes 112 to be moved from the closing position 130b to the opening position 130a.

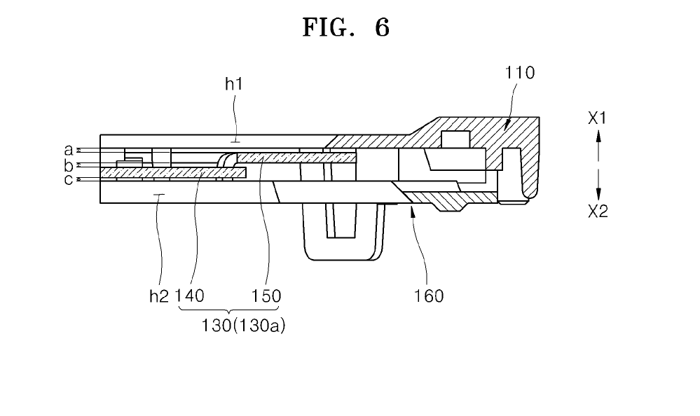

In order for the blades 130 to be stably rotated between the opening position 130a and the closing position 130b as described above, a predetermined clearance for rotation of the blades 130 is provided. FIG. 6 is a partial cross-sectional view of the lens barrier 100 of FIG. 5. Referring to FIG. 6, in order for the blades 130 to move from the opening position 130a to the closing position 130b or from the closing position 130b to the opening position 130a, a predetermined clearance is formed in the optical axis direction A between the driving blades 140 and the driven blades 150, between the driving blades 140 and the driving member 160, and between the driven blades 150 and the base 110. For example, a clearance a may be formed between the driven blades 150 and the base 110, a clearance b may be formed between the driving blades 140 and the driven blades 150, and a clearance c may be formed between the driving blades 140 and the driving member 160.

However, if the lens barrier 100 vibrates or vibrations are transferred thereto, noise may be caused due to the clearances a, b, and c. For example, noise may be generated as the driven blades 150 and the base 110, the driving blades 140 and the driven blades 150, or the driving blades 140 and the driving member 160, which are respectively separated from each other in the optical axis direction A due to vibration, contact (or crash into) each other. Vibrations transferred to the lens barrier 100 may be generated by the vibration module 45 (see FIG. 2B) included in the main body 40 of the electronic apparatus 1. However, vibrations may also be generated by an external force applied from the outside of the electronic apparatus 1.

According to an embodiment, a structure to minimize or reduce noise even if the lens barrier 100 vibrates or vibrations are transferred thereto may be provided. This will be described in detail below.

According to an embodiment, a forward guide 1601 for moving the driving member 160 so that the driving member 160 approaches the blades 130 along the optical axis A in the front direction X1 and a backward guide 1602 for moving the driving member 160 in the rear direction X2 along the optical axis A to be away from the blades 130 may be included in at least one of the driving member 160 and the base 110.

For example, referring to FIGS. 4A and 4B, a plurality of forward guides 1601 are formed on a rear surface 160b of the driving member 160, and a plurality of backward guides 1602 may be formed on a front surface 160a of the driving member 160. A forward supporting portion 1101 that contacts the forward guide 1601 and that supports a forward movement of the driving member 160 and a rear supporting portion 1102 that contacts the backward guide 1602 and supports a rear movement of the driving member 160 may be formed on the base 110. The forward supporting portion 1101 may protrude from a lateral portion of the base 110, and the rear supporting portion 1102 may protrude from the rear surface 110b of the base 110.

When the driving member 160 rotates in the first direction R1 when the blades 130 are in the closing position 130b, the forward guide 1601 contacts the forward supporting portion 1101 to guide the forward movement of the driving member 160. Accordingly, a clearance between the driving member 160 and the blades 130 and a clearance between the driving member 160 and the base 110 may be reduced. The forward guide 1601 may be formed at a rear surface groove 166 and may have an inclined surface downwardly inclined along the first direction R1. For example, the forward guide 1601 may have a height that decreases along the first direction R1.

Also, when the driving member 160 rotates in the second direction R2 when the blades 130 are at the closing position 130b, the backward guide 1602 contacts the rear supporting portion 1102 to guide the rear movement of the driving member 160. Accordingly, a clearance between the driving member 160 and the blades 130 and a clearance between the driving member 160 and the base 110 may increase. The backward guide 1602 may be formed at a front surface groove 165 and may have an inclined surface downwardly inclined along the first direction R1. For example, the backward guide 1602 may have a height that decreases along the first direction R1.

As described above, as the driving member 160 rotates when the blades 130 are at the closing position 130b, the clearance between the driving member 160 and the base 110 may vary due to the forward guide 1601 and the backward guide 1602. However, when the blades 130 rotate from the opening position 130a to the closing position 130b or from the closing position 130b to the opening position 130a, the clearance between the driving member 160 and the base 110 may be constant or uniform. The forward guide 1601 and the forward supporting portion 1101 may not contact each other while the blades 130 rotate. If the forward guide 1601 and the forward supporting portion 1101 contact each other while the blades 130 rotate, the driving member 160 moves in the front direction X1 along the optical axis A, which may hinder the rotation of the blades 130. Accordingly, reliability of opening and closing functions of the first and second open portions h1 and h2 may be reduced. However, according to an embodiment, while the blades 130 rotate, the driving member 160 does not move along the optical axis A, and thus, rotation of the blades 130 may take place smoothly. A location and a shape of the forward guide 1601 and the forward supporting portion 1101 may be designed such that there is no contact between the forward guide 1601 and the forward supporting portion 1101 while the blades 130 rotate.

Referring to FIG. 5, when the blades 130 are at the closing position 130b, if the driving member 160 rotates along the first direction R1, the driving member 160 moves in the front direction X1 along the optical axis A, thereby pressing a portion of the driving blades 140. The driving blades 140 that are pressed in the front direction X1 press the driven blades 150 in the front direction X1, and the driven blades 150 press the base 110 in the front direction X1. Accordingly, by removing or reducing a clearance between the base 110, the driven blades 150, the driving blades 140, and the driving member 160, noise may be reduced even if vibrations are transferred to the lens barrier 100.

When the plurality of blades 130 are at the closing position 130b, if the driving member 160 rotates in the second direction R2 to move in the rear direction X2 along the optical axis A, a contact between the driving blades 140 and the driving member 160 is stopped, and pressing of the driving blades 140 is stopped accordingly. Thus, a sufficient clearance may be provided between the base 110, the driven blades 150, the driving blades 140, and the driving member 160. Accordingly, the blades 130 may stably rotate from the closing position 130b to the opening position 130a.

If just the forward guide 1601 is included without the backward guide 1602, even when the driving member 160 rotates in the second direction R2, it may be difficult to stably move the driving member 160 in the rear direction X2. This is because, unless an additional driving force to move the driving member 160 in the rear direction X2 is provided, the forward guide 1601 may not be substantially involved in the movement in the rear direction X2. However, according to an embodiment, by using the backward guide 1602, when the driving member 160 rotates in the second direction R2, the driving member 160 may be reliably separated from the driving blades 140 (e.g., increasing clearance), thereby securing a stable operation of the driving blades 140.

Hereinafter, the description will describe movement of the driving member 160 in the front direction X1 or the rear direction X2 along the optical axis A via the forward guide 1601 and the backward guide 1602 formed in the driving member 160.

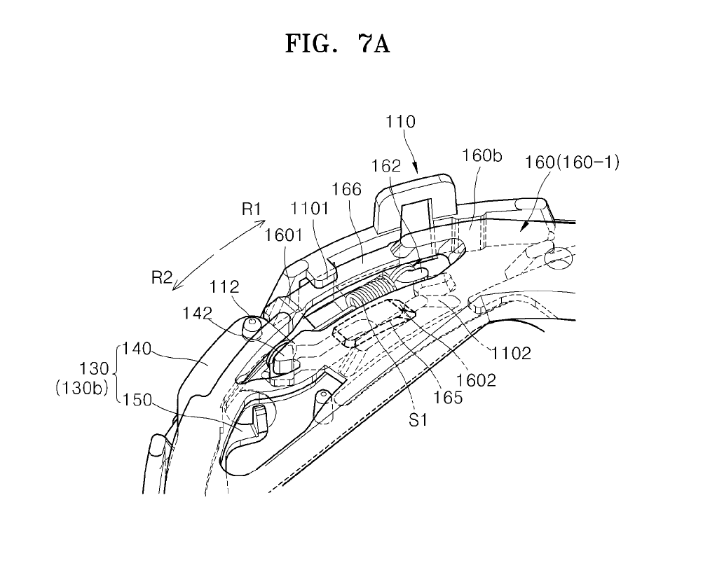

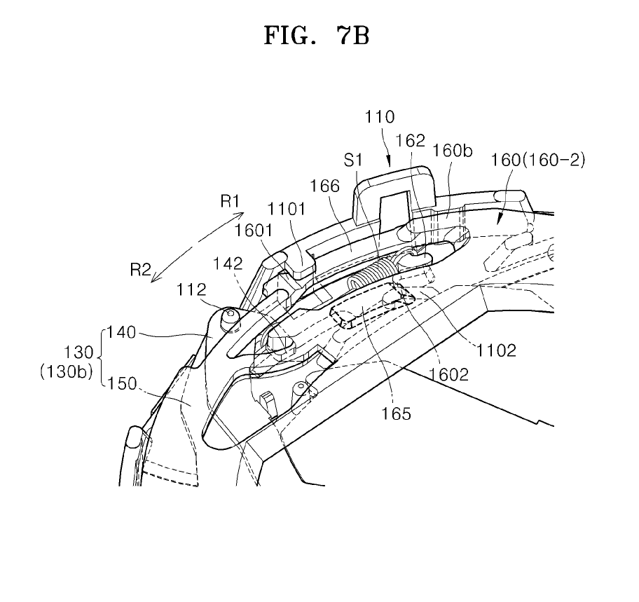

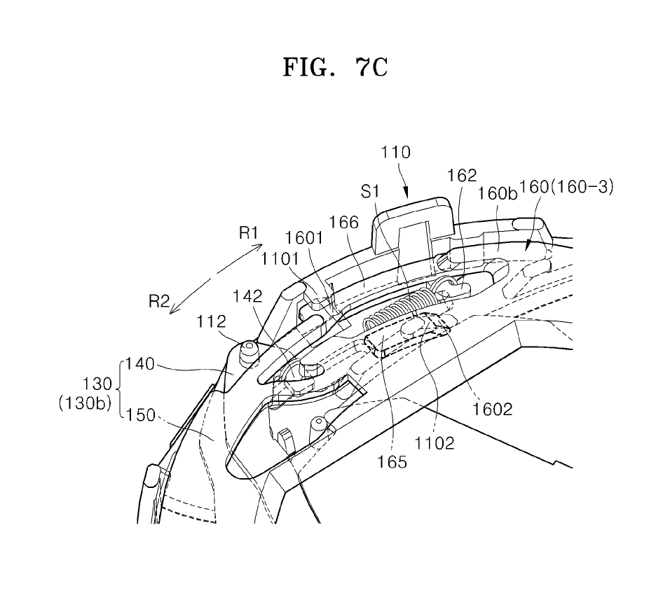

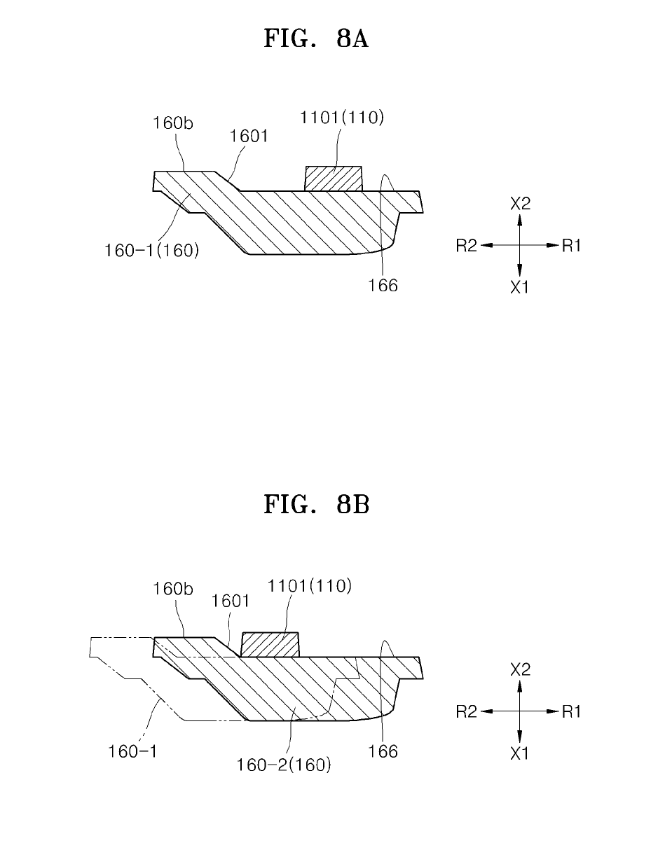

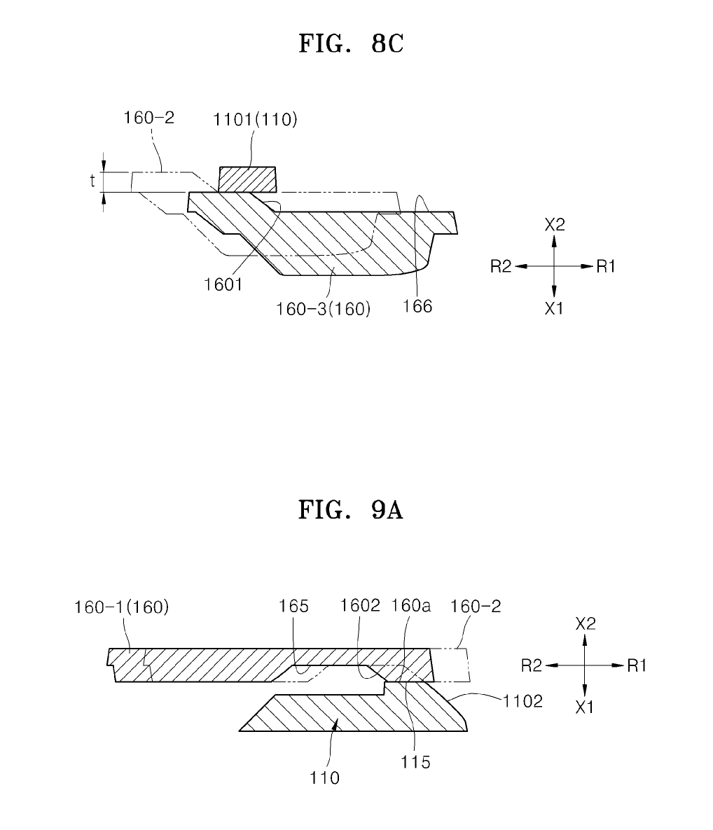

FIGS. 7A through 7C are partial expanded views of FIG. 5, sequentially illustrating operating states of the base 110, the blade 130, and the driving member 160 as the driving member 160 rotates in the first direction R1. Referring to FIG. 7A, the blades 130 are located at the opening position 130a, and referring to FIGS. 7B and 7C, the blades 130 are located at the closing position 130b. FIGS. 8A through 8C are cross-sectional diagrams illustrating the forward guide 1601 of the driving member 160 and the forward supporting unit 1101 of the base 110 of FIGS. 7A through 7C. A reference numeral 160-1 denotes the driving member 160 of FIG. 7A, a reference numeral 160-2 denotes the driving member 160 of FIG. 7B, and a reference numeral 160-3 denotes the driving member 160 of FIG. 7C.

Referring to FIGS. 7A and 8A, when the blades 130 are located at the opening position 130a, the forward supporting portion 1101 of the base 110 does not contact the forward guide 1601 of the driving member 160-1. In this case, at least a portion of the forward supporting portion 1101 is inserted into the rear surface groove 166. In this state, when the driving member 160-1 rotates in the first direction R1, the forward guide 1601 of the driving member 160-2 approaches the forward supporting portion 1101 of the base 110 as illustrated in FIGS. 7B and 8B. At this time, the driving members 160-1 and 160-2 have not moved in the front direction X1 or the rear direction X2 along the optical axis A. While the driving members 160-1 and 160-2 rotate in the first direction R1, the blades 130 are moved from the opening position 130a to the closing position 130b.

As the driving member 160-2 is additionally rotated in the first direction R1, the forward guide 1601 of the driving member 160-2 contacts the forward supporting portion 1101 of the base 110. In this state, when the driving member 160-2 rotates in the first direction R1, the forward guide 1601 of the driving member 160-2 is pressed by the forward supporting portion 1101 of the base 110, and the driving member 160-3 is moved in the front direction X1 by a predetermined distance t along the optical axis A as illustrated in FIGS. 7C and 8C. Accordingly, a clearance between the driving member 160-3 and the base 110 in the optical axis direction A is reduced, and the driving member 160 may press the plurality of blades 130 in the front direction X1. Accordingly, a clearance between the base 110 and the blades 130 and a clearance between the blades 130 and the driving member 160 may also be smaller than a clearance at the opening position 130a.

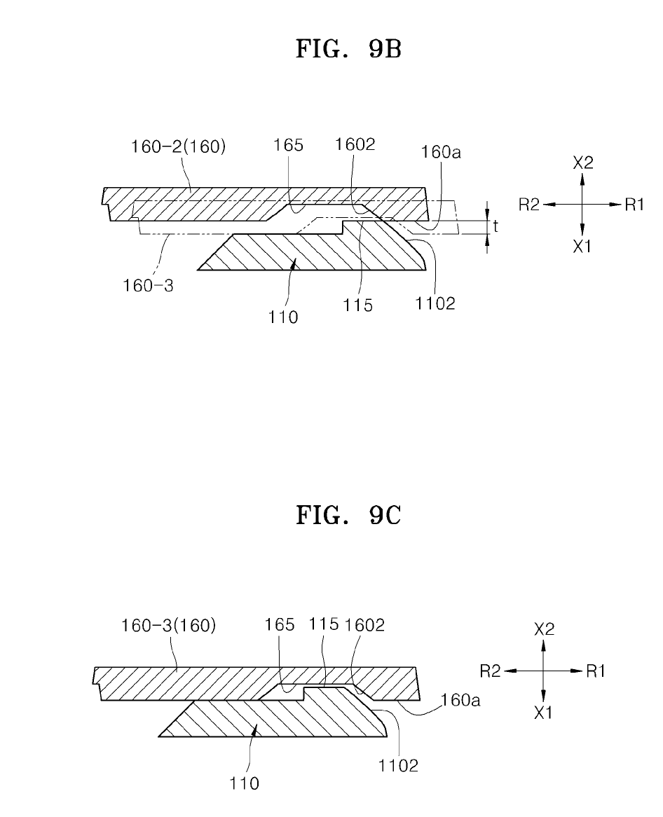

FIGS. 9A through 9C are cross-sectional diagrams illustrating the backward guide 1602 of the driving member 160 and the rear supporting unit 1102 of the base 110 of FIGS. 7A through 7C. FIG. 9C illustrates the driving member 160-3 moving in the front direction X1 along the optical axis A when the blades 130 are at the closing position 130b, and FIG. 9B illustrates the driving member 160-2 moving in the rear direction X2 along the optical axis A when the blades 130 are at the closing position 130b. FIG. 9A illustrates a state of the driving member 160-1 when the blades 130 are at the opening position 130a.

Referring to FIGS. 7C and 9C, when the driving member 160-3 has moved in the front direction X1, at least a portion of the rear supporting portion 1102 of the base 110 may be inserted into a front surface groove 165 formed in the driving member 160-3. In this state, as the driving member 160 rotates in the second direction R2, the backward guide 1602 approaches the rear supporting portion 1102 so that the backward guide 1602 and the rear supporting portion 1102 contact each other. When the backward guide 1602 contacts the rear supporting portion 1102, as the driving member 160-3 rotates in the second direction R2, the driving member 160 is pressed by the rear supporting portion 1102. Accordingly, the driving member 160-2 moves in the rear direction X2 by a predetermined distance t along the optical axis A as illustrated in FIGS. 7B and 9B. As the driving member 160-2 additionally rotates in the second direction R2, as illustrated in FIGS. 7A and 9A, the contact between the driving member 1602 and the rear supporting portion 1102 is stopped (e.g., the driving member 1602 and the rear supporting portion 1102 no longer contact each other). In this case, an end portion 115 of the base 110 may contact the front surface 160a of the driving member 160-1. Accordingly, in this manner, a clearance may be provided between the driving member 160-1 and the base 110.

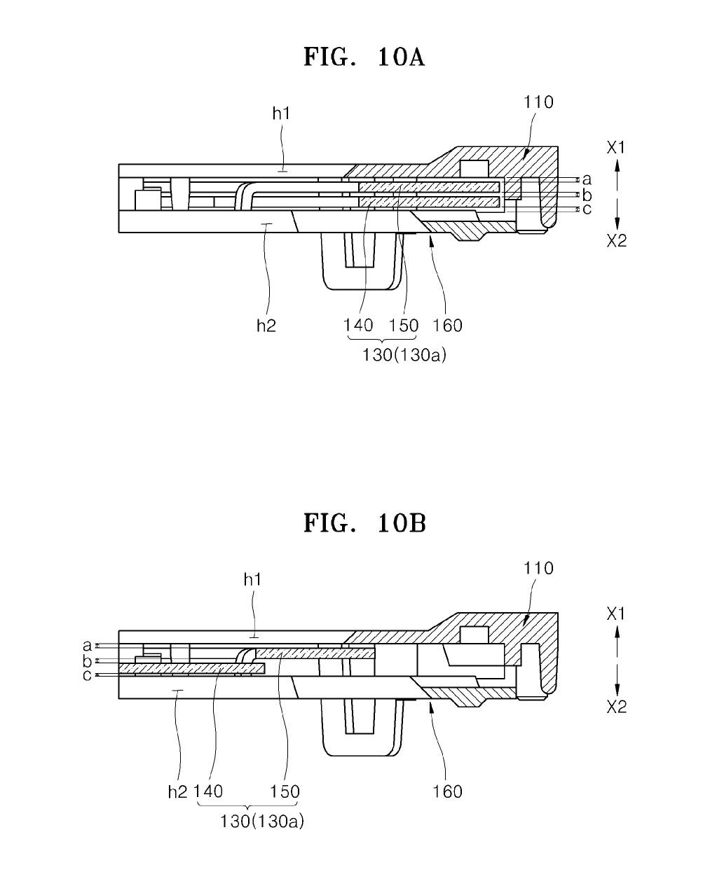

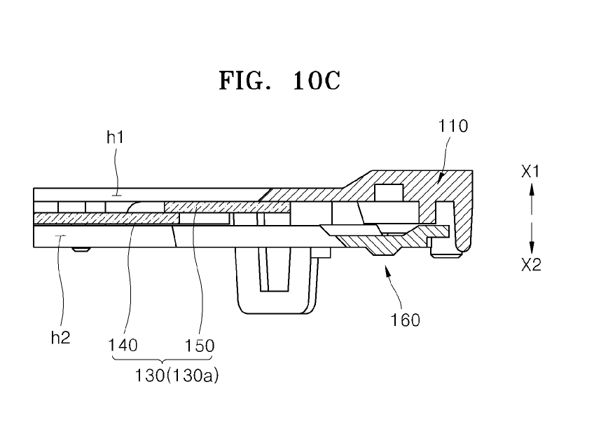

FIGS. 10A through 10C are partial cross-sectional views of the lens barrier 100 of FIGS. 7A through 7C. The blades 130 may rotate from the opening position 130a as illustrated in FIG. 10A to the closing position 130b as illustrated in FIG. 10B. A predetermined clearance C1 for rotation of the blades 103 may be provided while the blades 130 rotate from the opening position 130a to the closing position 130b. Referring to FIGS. 10A and 10B, the predetermined clearance may be formed between the base 110 and the driven blades 150, between the driven blades 150 and the driving blades 140, and between the driving blades 140 and the driving member 160. For example, a clearance a is formed between the base 110 and the driven blades 150, a clearance b is formed between the driven blades 150 and the driving blades 140, and a clearance c is formed between the driving blades 140 and the driving member 160, thereby providing the predetermined clearance C1 for rotation of the blades 130. The predetermined clearance C1 for the rotation of the blades 130 may be defined as a sum (C1=a+b+c) of the clearance a between the base 110 and the driven blades 150, the clearance b between the driven blades 150 and the driving blades 140, and the clearance c between the driving blades 140 and the driving member 160.

When the blades 130 are at the closing position 130b as illustrated in FIG. 10B, as the driving member 160 rotates in the first direction R1, the driving member 160 presses the driving blades 140 by moving in the front direction X1 along the optical axis A. The pressed driving blades 140 contact the driven blades 150 and may move the driven blades 150 in the front direction X1. As illustrated in FIG. 10C, a clearance between the base 110 and the driven blades 150, between the driven blades 150 and the driving blades 140, between the driving blades 140 and the driving member 160 may be eliminated or significantly reduced. For example, if the blades 130 do not rotate, that is, if the blades 130 are in a fixed state, the clearance C1 for the rotation of the blades 130 described above may be reduced. Accordingly, noise caused due to the clearance C1 for the rotation of the blades 130 may be prevented. When the blades 130 are at the closing position 130b as illustrated in FIG. 10C, when a sum of a clearance between the base 110 and the driven blades 150, a clearance between the driven blades 150 and the driving blades 140, and a clearance between the driving blades 140 and the driving member 160 is clearance C2, the clearance C2 may be reduced to approximately 1/9 or smaller of the clearance C1. For example, if the clearance C1 is about 0.36 mm, the clearance C2 may be about 0.04 mm.

In the above embodiments, it is described that the forward guide 1601 and the backward guide 1602 are both formed at the driving member 160, but the various embodiments are not limited thereto. For example, although not illustrated in the drawings, the forward guide 1601 and the backward guide 1602 may be both formed at the base 110, or the forward guide 1601 may be formed at the driving member 160 and the backward guide 1602 may be formed at the base 110.

Also, although the first barrel 20 and the base 110 or the like are coupled by insertion in the above-described embodiments, any typical coupling method such as a bolt coupling or adhesive coupling may be used. Also, although the base 110 described above is disposed at the front part of the plurality of blades 130 to be formed as a single unit with a front panel, the embodiments are not limited thereto, and the base 110 and the front panel may also be separate members.

The rotation of the driving member 160 via rotation of the first barrel 20 is described as an example of a method of transferring a driving force to the driving member 160 by the first barrel 20. However, the embodiments are not limited thereto, and if the first barrel 20 moves straight along the optical axis A, the driving member 160 may also be configured to rotate due to a straight movement of the first barrel 20. Also, although the driving member 160 is described as moving in the front direction X1 or the rear direction X2 along the optical axis A while rotating, the embodiments are not limited thereto, and the driving member 160 may also move along the optical axis A without rotating.

As described above, according to the lens barrier, the barrel assembly, and the electronic apparatus including the barrel assembly of the one or more of the above embodiments, a sufficient clearance for rotation of the blades may be provided when the blades rotate, and when the blades do not rotate, the clearance may be reduced. Accordingly, an open portion that provides an optical path may be stably opened or closed, and at the same time, even if vibration is generated, noise may be reduced.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The terminology used herein is for the purpose of describing the particular embodiments and is not intended to be limiting of exemplary embodiments of the invention. In the description of the embodiments, certain detailed explanations of related art are omitted when it is deemed that they may unnecessarily obscure the essence of the invention.

The apparatus described herein may comprise a processor, a memory for storing program data to be executed by the processor, a permanent storage such as a disk drive, a communications port for handling communications with external devices, and user interface devices, including a display, touch panel, keys, buttons, etc. When software modules are involved, these software modules may be stored as program instructions or computer readable code executable by the processor on a non-transitory computer-readable media such as magnetic storage media (e.g., magnetic tapes, hard disks, floppy disks), optical recording media (e.g., CD-ROMs, Digital Versatile Discs (DVDs), etc.), and solid state memory (e.g., random-access memory (RAM), read-only memory (ROM), static random-access memory (SRAM), electrically erasable programmable read-only memory (EEPROM), flash memory, thumb drives, etc.). The computer readable recording media may also be distributed over network coupled computer systems so that the computer readable code is stored and executed in a distributed fashion. This computer readable recording media may be read by the computer, stored in the memory, and executed by the processor.

Also, using the disclosure herein, programmers of ordinary skill in the art to which the invention pertains may easily implement functional programs, codes, and code segments for making and using the invention.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, JAVA®, assembler, or the like, with the various algorithms being implemented with any combination of data structures, objects, processes, routines or other programming elements. Functional aspects may be implemented in algorithms that execute on one or more processors. Furthermore, the invention may employ any number of conventional techniques for electronics configuration, signal processing and/or control, data processing and the like. Finally, the steps of all methods described herein may be performed in any suitable order unless otherwise indicated herein or otherwise clearly contradicted by context.

For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. The words “mechanism”, “element”, “unit”, “structure”, “means”, and “construction” are used broadly and are not limited to mechanical or physical embodiments, but may include software routines in conjunction with processors, etc.

The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention as defined by the following claims. Therefore, the scope of the invention is defined not by the detailed description of the invention but by the following claims, and all differences within the scope will be construed as being included in the invention.

No item or component is essential to the practice of the invention unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

What is claimed is:

1. A lens barrier comprising:
a base having an open portion that provides an optical path;
a plurality of blades that are rotatably mounted to the base and movable between an opening position where the open portion is opened and a closing position where the open portion is closed; and
a driving member that provides a driving force to the plurality of blades to rotate the plurality of blades,
wherein a forward guide, for moving the driving member forward along an optical axis such that the driving member approaches the plurality of blades, and a backward guide, for moving the driving member away from the plurality of blades when the plurality of blades is at the closing position, are formed at at least one of the driving member or the base.

2. The lens barrier of claim 1, wherein the driving member is rotatable in a first direction and a second direction opposite the first direction, and
wherein, when the plurality of blades is at the closing position, a clearance between the driving member and the plurality of blades is reduced as the driving member rotates in the first direction, and
wherein, when the plurality of blades is at the closing position, the clearance between the driving member and the plurality of blades increases as the driving member rotates in the second direction.

3. The lens barrier of claim 2, wherein the forward guide is formed on a rear surface of the driving member, and
the backward guide is formed on a front surface of the driving member.

4. The lens barrier of claim 3, wherein the forward guide is downwardly inclined in the first direction.

5. The lens barrier of claim 3, wherein the backward guide is downwardly inclined in the first direction.

6. The lens barrier of claim 3, wherein the base comprises a forward supporting portion that contacts the forward guide and a rear supporting portion that contacts the backward guide.

7. The lens barrier of claim 2, wherein the plurality of blades is disposed between the base and the driving member.

8. The lens barrier of claim 7, wherein, when the plurality of blades is at the closing position, a clearance between the driving member and the base varies as the driving member rotates.

9. The lens barrier of claim 7, wherein, when the plurality of blades move from the opening position to the closing position, a clearance between the driving member and the base is constant.

10. A barrel assembly comprising a barrel that supports at least one lens and a lens barrier that is disposed in front of the barrel and that is moved in a direction to cross an optical axis of the lens to open or close the lens,
wherein the lens barrier comprises:
a base having an open portion that provides an optical path;
a plurality of blades that are rotatably mounted to the base and movable between an opening position where the open portion is opened and a closing position where the open portion is closed; and
a driving member that provides a driving force to the plurality of blades to rotate the plurality of blades,
wherein a forward guide for moving the driving member forward along an optical axis such that the driving member approaches the plurality of blades and a backward guide for moving the driving member away from the plurality of blades when the plurality of blades is at the closing position are formed at at least one of the driving member or the base.

11. The barrel assembly of claim 10, wherein the driving member is rotatable in a first direction and a second direction opposite to the first direction, and
wherein, when the plurality of blades is at the closing position, a clearance between the driving member and the plurality of blades is reduced as the driving member rotates in the first direction, and
wherein, when the plurality of blades is at the closing position, the clearance between the driving member and the plurality of blades increases as the driving member rotates in the second direction.

12. The barrel assembly of claim 11, wherein the forward guide is formed on a rear surface of the driving member, and
the backward guide is formed on a front surface of the driving member.

13. The barrel assembly of claim 12, wherein the forward guide is downwardly inclined in the first direction.

14. The barrel assembly of claim 12, wherein the backward guide is downwardly inclined in the first direction.

15. The barrel assembly of claim 12, wherein the base comprises a forward supporting portion that contacts the forward guide and a rear supporting portion that contacts the backward guide.

16. The barrel assembly of claim 11, wherein the plurality of blades is disposed between the base and the driving member.

17. The barrel assembly of claim 16, wherein, when the plurality of blades is at the closing position, a clearance between the driving member and the base varies as the driving member rotates.

18. The barrel assembly of claim 16, wherein, when the plurality of blades move from the opening position to the closing position, the clearance between the driving member and the base is constant.

19. An electronic apparatus comprising:
a main body including a vibration module;
a barrel that supports at least one lens and is movably disposed in the main body to be protrudable from a front part of the main body; and
a lens barrier that is disposed in front of the barrel and that is moved in a direction to cross an optical axis of the lens to open or close the lens,
wherein the lens barrier comprises:
a base having an open portion that provides an optical path;
a plurality of blades that are rotatably mounted to the base and movable between an opening position where the open portion is opened and a closing position where the open portion is closed; and
a driving member that provides a driving force to the plurality of blades to rotate the plurality of blades,
wherein a forward guide for moving the driving member forward along an optical axis such that the driving member approaches the plurality of blades and a backward guide for moving the driving member away from the plurality of blades when the plurality of blades is at the closing position are formed at at least one of the driving member or the base.
